(19) United States
(12) Patent Application Publication
(10) Pub. No.: US 2011/0279368 A1
(43) Pub. Date: Nov. 17, 2011

(54) INFERRING USER INTENT TO ENGAGE A MOTION CAPTURE SYSTEM

(75) Inventors: Christian Klein, Duvall, WA (US); Andrew Mattingly, Kirkland, WA (US); Ali Vassigh, Redmond, WA (US); Chen Li, Redmond, WA (US); Arjun Dayal, Redmond, WA (US)

(73) Assignee: MICROSOFT CORPORATION, Redmond, WA (US)

(21) Appl. No.: 12/778,790

(22) Filed: May 12, 2010

(51) Int. Cl. G06K 9/00; G06F 3/033; H04N 7/18

(52) U.S. Cl. 345/158; 382/128; 348/77; 348/E05.024

(57) ABSTRACT

Techniques are provided for inferring a user's intent to interact with an application run by a motion capture system. Deliberate user gestures to interact with the motion capture system are disambiguated from unrelated user motions within the system's field of view. An algorithm may be used to determine the user's aggregated level of intent to engage the system. Parameters in the algorithm may include posture and motion of the user's body, as well as the state of the system. The system may develop a skeletal model to determine the various parameters. If the system determines that the parameters strongly indicate an intent to engage the system, then the system may react quickly. However, if the parameters only weakly indicate an intent to engage the system, it may take longer for the user to engage the system.

### CROSS-REFERENCE TO RELATED APPLICATION

The following application is cross-referenced and incorporated by reference herein in its entirety:

U.S. patent application Ser. No. 12/688,808, entitled “RECOGNIZING USER INTENT IN MOTION CAPTURE SYSTEM,” by Markovic, filed on Jan. 15, 2010.

### BACKGROUND

Motion capture systems obtain data regarding the location and movement of a human or other subject in a physical space, and can use the data as an input to an application in a computing system. Many applications are possible, such as for military, entertainment, sports and medical purposes. Optical systems, including those using visible and invisible, e.g., infrared, light, use cameras to detect the presence of a human in a field of view. Markers can be placed on the human to assist in detection, although markerless systems have also been developed. Some systems use inertial sensors which are carried by, or attached to, the human to detect movement. For example, in some video game applications, the user holds a wireless controller which can detect movement while playing a game.

While many systems are able to detect motion, it can be difficult to determine whether the motion is an intent to engage the system. Engaging the system refers to a deliberate user input that is intended to influence the system. For example, the user might use hand gestures to control an on-screen menu or control actions in a video game. An example of misinterpreting a user's intent is misinterpreting a user's hand-gestures to another person as an intent to engage the system. Any user within the system's field of view might be misinterpreted as intending to engage the system. The use of special markers, sensors, controllers, and the like might help to avoid mistakes, but can be cumbersome for the user. Therefore, further refinements are needed which allow a human to interact more naturally with an application within a motion capture system.

### SUMMARY

A method, motion capture system and computer readable storage device are provided for inferring a user's intent to interact with an application run by a motion capture system. Techniques described herein do not require any special markers, sensors, controllers, and the like to interact with the system. Moreover, techniques described herein allow a human to interact naturally with an application within a motion capture system.

Techniques described herein are able to disambiguate between deliberate user gestures to interact with the motion capture system and unrelated user motions within the system's field of view. An algorithm may be used to determine the user's aggregated level of intent to engage the system. Variables in the algorithm may include posture and motion of the user's body, as well as the state of the system. Note that the data upon which intent is inferred may be something other than actions the user performs to cause an input to alter an application performed by the system. For example, the system could infer user's intent to engage the system based in part on the angle of the user's hips to the system. However, once engaged with the system, a game application may react based on gestures made by the user's hands. Therefore, hand gestures that are not intended to influence the system may be ignored by the system. Techniques described herein are able to determine which user (or users) are intending to interact with the system when additional non-participating users are present within the system's field of view.

One embodiment includes a method of determining user intent to engage a motion capture system. Data that describes a person's body within a field of view of a motion capture system is collected over time. A model for the person's body for each time period is determined based on the data. A value for each parameter for each of the models is determined. The values of each of the parameters define an aspect of the person's body that pertains to a level of intent to engage the system. An aggregated level of intent to engage the system is determined on the parameter values for each time period. Selected user actions captured by the motion capture system are interpreted as input to the system if the aggregated level of intent exceeds a threshold. The selected user actions captured by the motion capture system are interpreted as noise if the aggregated level of intent does not exceed the threshold.

One embodiment includes a motion capture system which comprises an image camera component, a display, and logic in communication with the image camera component and the display. The logic is operable to collect data that describes a person's body over time within a field of view of an image camera component. The logic is operable to generate a model for the person's body for each of a plurality of time periods based on the data. The logic is operable to generate a value for each of a plurality of parameters for each of the models. Each of the parameters defines an aspect of the person's body that pertains to a level of intent to engage the motion capture system. The logic is operable to aggregate a level of intent to engage the system based on the values for the parameters for each of the models. The logic is operable to determine whether the aggregated level of intent strongly indicates intent to engage the motion capture system. The logic is operable to interpret selected user actions captured by the depth camera as input to the motion capture system if the aggregated level of intent strongly indicates intent to engage the motion capture system. The logic is operable to determine whether the aggregated level of intent weakly indicates intent to engage the motion capture system. The logic is operable to provide feedback that indicates that the motion capture system is aware of the presence of the person, but not allowing the person to engage the motion capture system, if the aggregated level of intent weakly indicates intent to engage the motion capture system. The logic is operable to interpret the selected user actions as noise if the aggregated level of intent neither strongly nor weakly indicates intent to engage the motion capture system.

One embodiment includes a computer readable storage device having computer readable software stored thereon for programming at least one processor to perform a method in a motion capture system. The method comprises establishing a mode in which selected user actions are considered to be noise, collecting data that describes a person's body over time within a field of view of a motion capture system, generating a model for the person's body for each of a plurality of time periods based on the data, generating a value for each of a plurality of parameters for each of the models. Each of the parameters defines an aspect of the person's body that pertains to a level of intent to engage the system. The method further comprises determining scores for each of the values. Each score represents a level of intent that is inferred for the associated value of the parameter. The method further comprises determining a level of intent that is inferred for the present time period based on the scores from the present time period, interpreting the selected user actions captured by the motion capture system as input to the system if the level of intent exceeds a threshold, modifying the scores for the parameters from previous time intervals, determining an aggregated level of intent that is inferred based on the scores from the present time period and the modified scores from previous time intervals, and interpreting the selected user actions captured by the motion capture system as input to the system if the aggregated level of intent exceeds a threshold.

This summary is provided to introduce a selection of concepts in a simplified form that are further described below in the description. This summary is not intended to identify key features or essential features of the claimed subject matter, nor is it intended to be used to limit the scope of the claimed subject matter.

### BRIEF DESCRIPTION OF THE DRAWINGS

FIGS. 1a and 1b depict an example embodiment of a motion capture system in which a user interacts with an application which simulates a boxing match.

FIG. 2 depicts an example block diagram of the motion capture system 10 of FIG. 1a.

FIG. 3 depicts a method for enabling a person to interact with a motion capture system.

FIG. 4a depicts an example method for determining a model of a person in the field of view of a motion capture system.

FIG. 4b depicts an example model of a person that may be generated by the process of FIG. 4a.

FIG. 4c depicts another example model of a person that may be generated by the process of FIG. 4a.

FIG. 5 is a flowchart of one embodiment of a process of determining which user or users are intending to engage the system when there are more users than appropriate for the application.

FIG. 6 is a flowchart of one embodiment of a process of determining whether a model indicates that a user intends to engage with the system.

FIG. 7 depicts an example block diagram of a computing environment that may be used in the motion capture system of FIG. 1a

FIG. 8 depicts an example block diagram of a computing environment that may be used in the motion capture system of FIG. 1a.

### DETAILED DESCRIPTION

Various techniques are provided for allowing a person, or group of people, to easily interact with an application in a motion capture system. A depth camera system can track a person's location and movement in a physical space and evaluate them to determine whether the person intends to engage, e.g., interact, with the application. The depth camera system may develop a skeletal model of the user and determine values for various parameters based on the skeletal model. In some cases, the system may analyze skeletal data from multiple people in the system's field of view and determine which people are intending to interact with the system.

In some embodiments, if the user is not currently engaged with the system, the system continues to determine the user's intent to engage the system over time. If the system determines that the user's actions, posture, etc. strongly indicate an intent to engage the system, then the system may react quickly. However, if the user's actions only weakly indicate an intent to engage the system, it may take longer for the user to engage the system. If the user's actions weakly indicate an intent to engage the system, the system may prompt the user to help the process along. For example, the system might indicate that it is aware of the user, but note that the system is presently in a mode that does not allow the user to interact with the application through actions such as hand gestures.

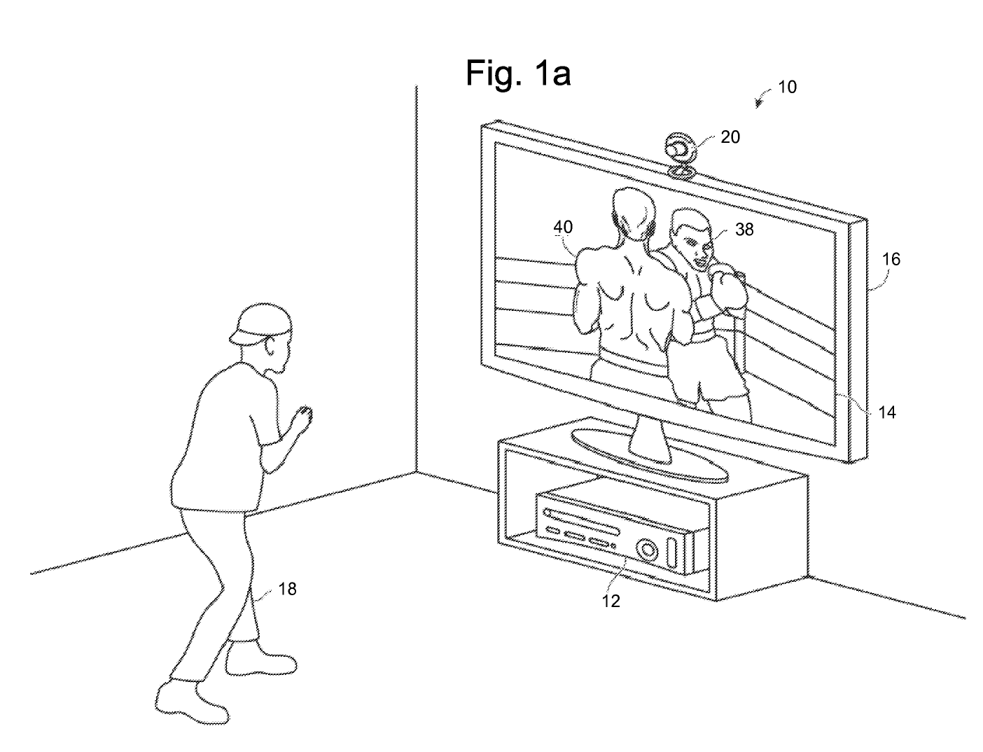

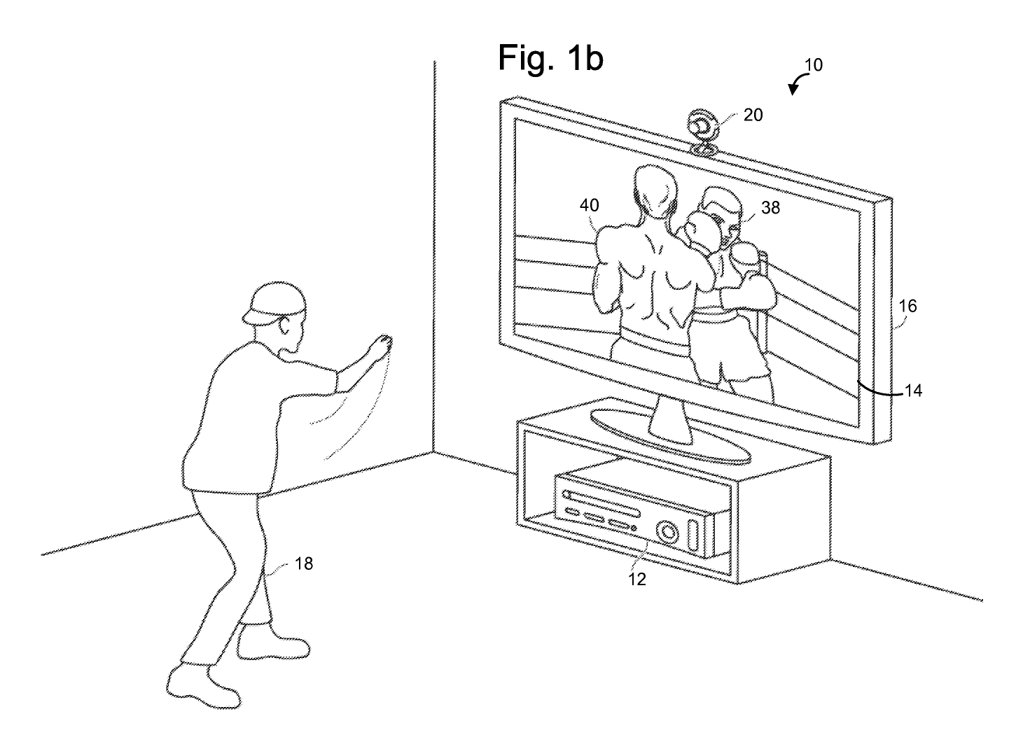

FIGS. 1a and 1b depict an example embodiment of a motion capture system 10 in which a person 18 interacts with an application which simulates a boxing match. The motion capture system 10 is used to recognize, analyze, and/or track a human target such as the person 18, also referred to as user or player. The example is used for purposes of providing an example environment. However, determining whether a user intends to engage a motion capture system 10 is not limited to this example embodiment.

As shown in FIG. 1a, the motion capture system 10 may include a computing environment 12 such as a computer, a gaming system or console, or the like. The computing environment 12 may include hardware components and/or software components to execute applications such as educational and/or entertainment purposes. Embodiments described herein may be implemented in software, in hardware, or in some combination of software and hardware. Example computing platforms for software embodiments are described below. In general, the term “logic” as used herein may refer to either software or hardware (or a combination thereof). An example of hardware implementation is an application specific integrated circuit (ASIC).

The motion capture system 10 may further include a depth camera system 20. The depth camera system 20 may be, for example, a camera that may be used to visually monitor one or more people, such as the person 18, such that gestures and/or movements performed by the people may be captured, analyzed, and tracked to perform one or more controls or actions within an application.

The motion capture system 10 may be connected to a audio/visual device 16 such as a television, a monitor, a high-definition television (HDTV), or the like that provides a visual and audio output to the user. An audio output can also be provided via a separate device. To drive the audio/visual device 16, the computing environment 12 may include a video adapter such as a graphics card and/or an audio adapter such as a sound card that provides audio/visual signals associated with an application. The audio/visual device 16 may be connected to the computing environment 12 via, for example, an S-Video cable, a coaxial cable, an HDMI cable, a DVI cable, a VGA cable, or the like.

The person 18 may be tracked using the depth camera system 20 such that the gestures and/or movements of the person are captured and interpreted as input controls to the application being executed by computer environment 12. Thus, according to one embodiment, the user 18 may move his or her body to control the application.

As an example, the application can be a boxing game in which the person 18 participates and in which the audio/visual device 16 provides a visual representation of a boxing opponent 38 to the person 18. The computing environment 12 may also use the audio/visual device 16 to provide a visual representation of a player avatar 40 which represents the person, and which the person can control with his or her bodily movements.

For example, as shown in FIG. 1b, the person 18 may throw a punch in physical space, e.g., a room in which the person is standing, to cause the player avatar 40 to throw a punch in a virtual space which includes a boxing ring. Thus, according to an example embodiment, the computer environment 12 and the depth camera system 20 of the motion capture system 10 may be used to recognize and analyze the punch of the person 18 in physical space such that the punch may be interpreted as an input to an application which simulates a boxing match, to control the player avatar 40 in the virtual space.

Other movements by the person 18 may also be interpreted as other controls or actions and/or used to animate the player avatar, such as controls to bob, weave, shuffle, block, jab, or throw a variety of different punches. Furthermore, some movements may be interpreted as controls that may correspond to actions other than controlling the player avatar 40. For example, in one embodiment, the player may use movements to end, pause, or save a game, select a level, view high scores, communicate with a friend, and so forth. The player may use movements to select the game or other application from a main user interface. Thus, a full range of motion of the user 18 may be available, used, and analyzed in any suitable manner to interact with an application.

The person can hold an object such as a prop when interacting with an application. In such embodiments, the movement of the person and the object may be used to control an application. For example, the motion of a player holding a racket may be tracked and used for controlling an on-screen racket in an application which simulates a tennis game. In another example embodiment, the motion of a player holding a toy weapon such as a plastic sword may be tracked and used for controlling a corresponding weapon in the virtual space of an application which provides a pirate ship.

The motion capture system 10 may further be used to interpret target movements as operating system and/or application controls that are outside the realm of games and other applications which are meant for entertainment and leisure. For example, virtually any controllable aspect of an operating system and/or application may be controlled by movements of the person 18.

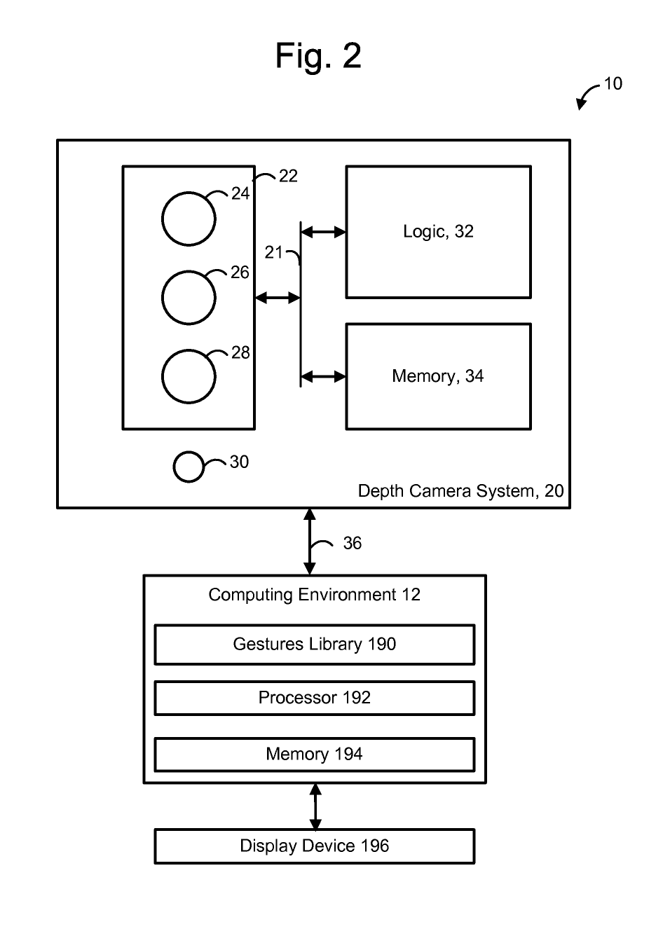

FIG. 2 depicts an example block diagram of the motion capture system 10 of FIG. 1a. The depth camera system 20 may be configured to capture video with depth information including a depth image that may include depth values, via any suitable technique including, for example, time-of-flight, structured light, stereo image, or the like. The depth camera system 20 may organize the depth information into “Z layers,” or layers that may be perpendicular to a Z axis extending from the depth camera along its line of sight.

The depth camera system 20 may include an image camera component 22, such as a depth camera that captures the depth image of a scene in a physical space. The depth image may include a two-dimensional (2-D) pixel area of the captured scene, where each pixel in the 2-D pixel area has an associated depth value which represents a linear distance from the image camera component 22.

The image camera component 22 may include an infrared (IR) light component 24, a three-dimensional (3-D) camera 26, and a red-green-blue (RGB) camera 28 that may be used to capture the depth image of a scene. For example, in time-of-flight analysis, the IR light component 24 of the depth camera system 20 may emit an infrared light onto the physical space and use sensors (not shown) to detect the backscattered light from the surface of one or more targets and objects in the physical space using, for example, the 3-D camera 26 and/or the RGB camera 28. In some embodiments, pulsed infrared light may be used such that the time between an outgoing light pulse and a corresponding incoming light pulse is measured and used to determine a physical distance from the depth camera system 20 to a particular location on the targets or objects in the physical space. The phase of the outgoing light wave may be compared to the phase of the incoming light wave to determine a phase shift. The phase shift may then be used to determine a physical distance from the depth camera system to a particular location on the targets or objects.

A time-of-flight analysis may also be used to indirectly determine a physical distance from the depth camera system 20 to a particular location on the targets or objects by analyzing the intensity of the reflected beam of light over time via various techniques including, for example, shuttered light pulse imaging.

In another example embodiment, the depth camera system 20 may use a structured light to capture depth information. In such an analysis, patterned light (i.e., light displayed as a known pattern such as grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the depth camera system to a particular location on the targets or objects.

According to another embodiment, the depth camera system 20 may include two or more physically separated cameras that may view a scene from different angles to obtain visual stereo data that may be resolved to generate depth information.

The depth camera system 20 may further include a microphone 30 which includes, e.g., a transducer or sensor that receives and converts sound waves into an electrical signal. Additionally, the microphone 30 may be used to receive audio signals such as sounds that are provided by a person to control an application that is run by the computing environment 12. The audio signals can include vocal sounds of the person such as spoken words, whistling, shouts and other utterances as well as non-vocal sounds such as clapping hands or stomping feet.

The depth camera system 20 may include logic 32 that is in communication with the image camera component 22. The logic 32 may include a standardized processor, a specialized processor, a microprocessor, or the like that may execute instructions. The logic 32 may also include hardware such as an ASIC, electronic circuitry, logic gates, etc.

The depth camera system 20 may further include a memory component 34 that may store instructions that are executed by the processor 32, as well as storing images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable tangible computer readable storage component. The memory component 34 may be a separate component in communication with the image capture component 22 and the processor 32 via a bus 21. According to another embodiment, the memory component 34 may be integrated into the processor 32 and/or the image capture component 22.

The depth camera system 20 may be in communication with the computing environment 12 via a communication link 36. The communication link 36 may be a wired and/or a wireless connection. According to one embodiment, the computing environment 12 may provide a clock signal to the depth camera system 20 via the communication link 36 that indicates when to capture image data from the physical space which is in the field of view of the depth camera system 20.

Additionally, the depth camera system 20 may provide the depth information and images captured by, for example, the 3-D camera 26 and/or the RGB camera 28, and/or a skeletal model that may be generated by the depth camera system 20 to the computing environment 12 via the communication link 36. The computing environment 12 may then use the model, depth information, and captured images to control an application. For example, as shown in FIG. 2, the computing environment 12 may include a gestures library 190, such as a collection of gesture filters, each having information concerning a gesture that may be performed by the skeletal model (as the user moves). For example, a gesture filter can be provided for each of: raising one or both arms up or to the side, rotating the arms in circles, flapping one's arms like a bird, leaning forward, backward, or to one side, jumping up, standing on one's toes by raising ones heels, walking in place, walking to a different location in the field of view/physical space, and so forth. By comparing a detected motion to each filter, a specified gesture or movement which is performed by a person can be identified. An extent to which the movement is performed can also be determined.

The data captured by the depth camera system 20 in the form of the skeletal model and movements associated with it may be compared to the gesture filters in the gesture library 190 to identify when a user (as represented by the skeletal model) has performed one or more specific movements. Those movements may be associated with various controls of an application.

The computing environment may also include a processor 192 for executing instructions which are stored in a memory 194 to provide audio-video output signals to the display device 196 and to achieve other functionality as described herein.

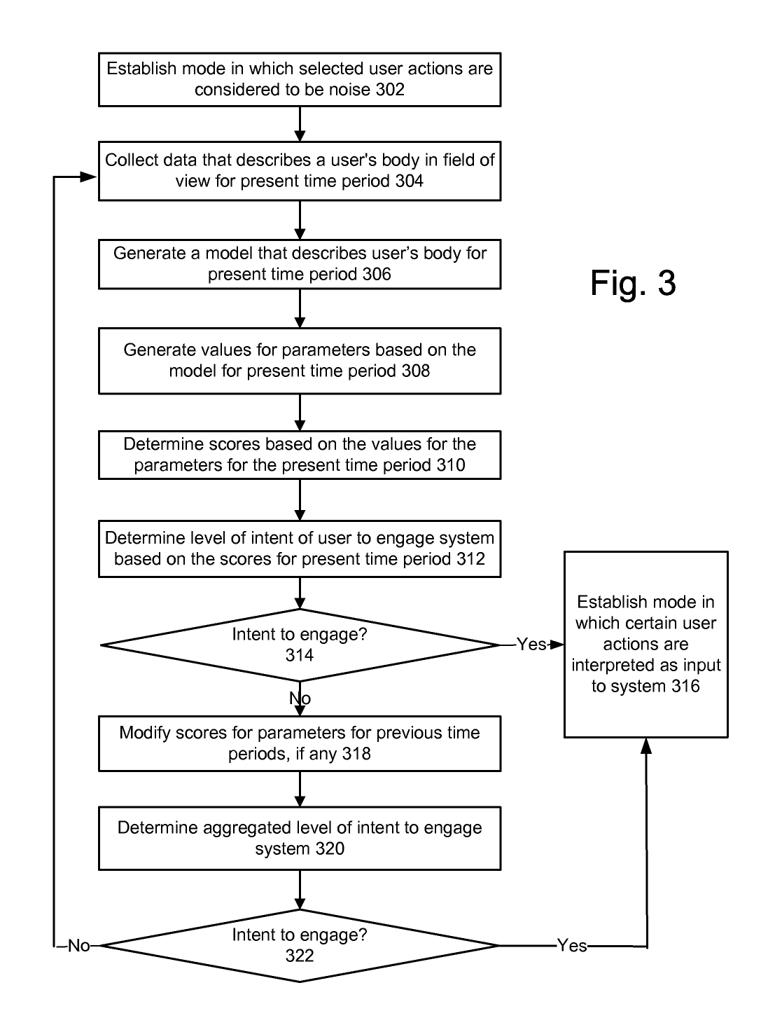

FIG. 3 depicts a method for enabling a person to engage a motion capture system. The method may be implemented using, for example, the depth camera system 20 and/or the computing environment 12 as discussed in connection with FIG. 2. Various steps in the process could be performed by a combination of software and/or hardware. The process starts with a mode in which the user is not engaged with the system (step 302). In this mode, selected user actions are interpreted as noise by the system, as opposed to deliberate user input to the system. For example, hand gestures may be interpreted as noise instead of deliberate attempts to affect an application being run by the system. The selected actions might depend on the application currently being run. For example, each application might have its own set of user actions that allow a user to enter input. Note that the process of FIG. 3 describes an example in which a single user is in the field of view. The process can be modified for a case in which multiple users are in the field of view. However, to facilitate explanation, the example of the single user will be described when discussing the process of FIG. 3.

Step 304 includes collecting data for a person in a field of view of the motion capture system. For example, the motion capture system creates depth information. The data collected in step 304 may cover a first time period. As one example for purposes of illustration, the time period could be one second; however, other lengths of time might be used. In some embodiments, the depth information pertains to one instant of time. Therefore, multiple sets of depth information could be collected for the time period.

In step 306, one or more models are generated for the person in the field of view. In one embodiment, step 306 includes generating skeletal data. Further details of generating skeletal data are discussed below. However, the model is not limited to skeletal data. For example, the model could include information that describes the direction of a person's gaze. The latter information is not necessarily based on skeletal data. In some embodiments, a single model is used for the given time period; however, any number of models may be used for a given time period.

In step 308, values for parameters that pertain to user intent to engage the system are determined for the present time period. Example parameters include the angle of the user's hips, shoulders, and/or face to the system. Further example parameters are discussed below. Values for the parameters may a numeric value, such as the actual number of degrees of hip rotation relative to the system.

Note that the parameters may be based on information that would not necessarily be used to allow the user to interact with an application that the system runs. For example, the parameters may be based on the angle of the user's hips relative to the system. However, the user's hip angle might not necessarily be used as input to affect the application (such as a game).

Also, note that the values for parameters may be based on motion data. For example, movement of the whole user's body might suggest that the user does not intend to engage the system. In contrast, if the user is still this may infer an intent to engage the system. Therefore, one parameter could be a movement parameter. The value for the movement parameter could be any metric (e.g., number, vector) that describes the movement.

In step 310, a score that reflects the user's intent to engage the system is determined for the values of each of the parameters. For example, if the user's hip angle indicates that the person is facing towards the system, then a high score may be assigned. However, if the person's hip angle indicates that that person is facing away from the system, then a low score may be assigned to that parameter. Also, note that the values for parameters may be based on motion data. For example, movement of the whole person's body might suggest that the person does not intend to engage the system. In contrast, if the person is still this may infer an intent to engage the system. Therefore, a high/medium/low score can be assigned to a motion parameter based on the relative amount of motion in the person's whole body, or some specific part of the person's body. Note that this score is representative of the present time period. The present time period may be any interval.

In step 312, a level of intent to engage with the system is determined for the present time period, based on the scores for the parameters from the present time period. In one embodiment, the score from each of the parameters is added to determine whether the values cross a threshold. However, other techniques can be used to determine whether the scores for the parameters indicate intent to engage the system. Note that an aggregated intent to engage the system may be based on scores for parameters for previous time periods, which will be discussed below in step 320.

If it is determined that the person intends to engage the system (step 314), then a mode is entered in step 316 in which selected user actions are interpreted as input to the system. The system may react to user actions that are pertinent to the application. For example, the system may react to a person's hand gestures to make selections in a user interface. Note that the data that was used to determine that the person intends to engage the system does not necessarily include the hand gestures. This mode may continue until a determination is made that the person intends to disengage from the system.

In step 318, scores for the parameters from previous time periods are modified in some manner. This step may help to achieve a consistent level of intent over time. In one embodiment, the scores for parameters are devalued over time. Many techniques can be used to devalue the impact of parameters over time. For example, the score for each parameter can be decayed over time.

In step 320, a determination is made as to whether an aggregated level of intent over time indicates a desire to engage the system. In one embodiment, the scores from parameters from the present time period and the devalued scores from the parameters from previous time are used to determine an aggregated level of intent. Note that if the present values for the parameters only weakly indicates an intent to engage the system, then the determination of step 314 might be take the path to step 318. However, by aggregating the level of intent from previous time periods, a sufficient level of intent may be inferred. In such a case, it may take longer for the user to engage the system. However, it may also be that more false positive gesture recognition errors can be excluded.

In step 322, if it is determined that the aggregated level of intent to engage the system is sufficiently high, then the process goes to step 316 in which selected user actions are interpreted as input to the system. However, if it is determined that the aggregated level of user intent to engage the system is not sufficiently high (in step 322), then the process returns to step 304 to collect data for the next time period. The process may continually loop until it is determined that the person intends to engage the system. Note that while an intent to disengage from the system is not explicitly shown in the process, the process may be modified to allow the user to either explicitly disengage, or to infer an intent to disengage by, for example, a period of inactivity.

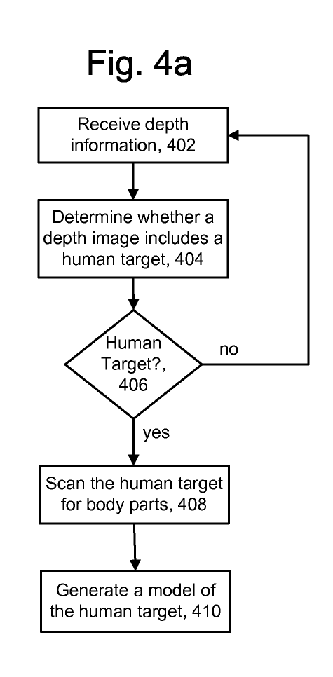

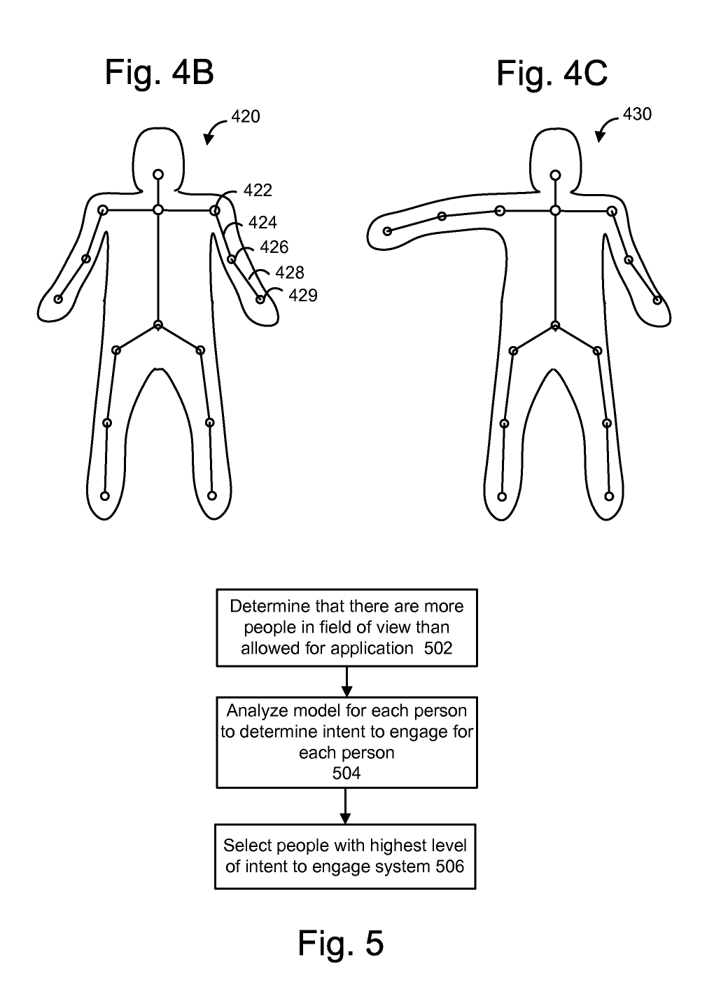

FIG. 4A depicts an example method for generating a model of a person within a field of view of a depth camera system. The example method may be implemented using, for example, the depth camera system 20 and/or the computing environment 12 as discussed in connection with FIG. 2. One or more people can be scanned to generate a model such as a skeletal model, a mesh human model, or any other suitable representation of a person. The model may then be analyzed to determine a level of intent to engage the system. The model may also be tracked to allow the user to interact with an application that is executed by the computing environment. However, as previously mentioned, different parameters of the model may be used to determine level of intent than those used to interact with the application. The scan to generate the model can occur when an application is started or launched, or at other times as controlled by the application of the scanned person.

According to one embodiment, at step 402, depth information is received, e.g., from the depth camera system. The depth camera system may capture or observe a field of view that may include one or more targets. In an example embodiment, the depth camera system may obtain depth information associated with the one or more targets in the capture area using any suitable technique such as time-of-flight analysis, structured light analysis, stereo vision analysis, or the like, as discussed. The depth information may include a depth image having a plurality of observed pixels, where each observed pixel has an observed depth value, as discussed.

The depth image may be downsampled to a lower processing resolution so that it can be more easily used and processed with less computing overhead. Additionally, one or more high-variance and/or noisy depth values may be removed and/or smoothed from the depth image; portions of missing and/or removed depth information may be filled in and/or reconstructed; and/or any other suitable processing may be performed on the received depth information may such that the depth information may used to generate a model such as a skeletal model, discussed in connection with FIGS. 4b and 4c.

At step 404, a determination is made as to whether the depth image includes a human target. This can include flood filling each target or object in the depth image comparing each target or object to a pattern to determine whether the depth image includes a human target. For example, various depth values of pixels in a selected area or point of the depth image may be compared to determine edges that may define targets or objects as described above. The likely Z values of the Z layers may be flood filled based on the determined edges. For example, the pixels associated with the determined edges and the pixels of the area within the edges may be associated with each other to define a target or an object in the capture area that may be compared with a pattern, which will be described in more detail below.

If there is a human in the field of view (step 406 is true), then step 408 is performed. If there is not a human (step 406 is false), then additional depth information is received at step 402.

The pattern to which each target or object is compared may include one or more data structures having a set of variables that collectively define a typical body of a human. Information associated with the pixels of, for example, a human target and a non-human target in the field of view, may be compared with the variables to identify a human target. In one embodiment, each of the variables in the set may be weighted based on a body part. For example, various body parts such as a head and/or shoulders in the pattern may have weight value associated therewith that may be greater than other body parts such as a leg. According to one embodiment, the weight values may be used when comparing a target with the variables to determine whether and which of the targets may be human. For example, matches between the variables and the target that have larger weight values may yield a greater likelihood of the target being human than matches with smaller weight values.

Step 408 includes scanning the human target for body parts. The human target may be scanned to provide measurements such as length, width, or the like associated with one or more body parts of a person to provide an accurate model of the person. In an example embodiment, the human target may be isolated and a bitmask of the human target may be created to scan for one or more body parts. The bitmask may be created by, for example, flood filling the human target such that the human target may be separated from other targets or objects in the capture area elements. The bitmask may then be analyzed for one or more body parts to generate a model such as a skeletal model, a mesh human model, or the like of the human target. For example, according to one embodiment, measurement values determined by the scanned bitmask may be used to define one or more joints in a skeletal model, discussed in connection with FIGS. 4b and 4c. The one or more joints may be used to define one or more bones that may correspond to a body part of a human.

For example, the top of the bitmask of the human target may be associated with a location of the top of the head. After determining the top of the head, the bitmask may be scanned downward to then determine a location of a neck, a location of the shoulders and so forth. A width of the bitmask, for example, at a position being scanned, may be compared to a threshold value of a typical width associated with, for example, a neck, shoulders, or the like. In an alternative embodiment, the distance from a previous position scanned and associated with a body part in a bitmask may be used to determine the location of the neck, shoulders or the like. Some body parts such as legs, feet, or the like may be calculated based on, for example, the location of other body parts. Upon determining the values of a body part, a data structure is created that includes measurement values of the body part. The data structure may include scan results averaged from multiple depth images which are provide at different points in time by the depth camera system.

Step 410 includes generating a model of the human target. In one embodiment, measurement values determined by the scanned bitmask may be used to define one or more joints in a skeletal model. The one or more joints are used to define one or more bones that correspond to a body part of a human. For example, FIG. 4b depicts an example model 420 of a person as set forth in step 410 of FIG. 4a, and FIG. 4c depicts another example model 430 of a person as set forth in step 410 of FIG. 4a.

Generally, each body part may be characterized as a mathematical vector defining joints and bones of the skeletal model. Body parts can move relative to one another at the joints. For example, a forearm segment 428 is connected to joints 426 and 429 and an upper arm segment 424 is connected to joints 422 and 426. The forearm segment 428 can move relative to the upper arm segment 424.

One or more joints may be adjusted until the joints are within a range of typical distances between a joint and a body part of a human to generate a more accurate skeletal model. The model may further be adjusted based on, for example, a height associated with the human target.

The skeletal model may be tracked such that physical movements or motions of the user 58 may act as a real-time user interface that adjusts and/or controls parameters of an application. For example, the tracked movements of a person may be used to manipulate on onscreen cursor, move an avatar or other on-screen character in an electronic role-playing game; to control an on-screen vehicle in an electronic racing game; to control the building or organization of objects in a virtual environment; or to perform any other suitable control of an application. As one particular example, by tracking user hand movements, the user is able to manipulate an onscreen cursor to navigate a user interface. Generally, any known technique for tracking movements of a person can be used.

Note that the model of the person is not limited to skeletal data. In one embodiment, feature recognition software is used to generate additional data for the model. For example, the direction of the person's gaze may be determined using feature recognition software.

Sometimes there may be more than one person within the field of view of the system. In some embodiments, the system is able to determine which of the people are intending to engage with the system and which are not. For example, two people may be playing a tennis game on the system while others are watching. However, those that are watching may be within the field of view. From time to time, those watching may switch with those playing.

FIG. 5 is a flowchart of one embodiment of a process of determining which users are intending to engage the system when there are more users than appropriate for the application. The example method may be implemented using, for example, the depth camera system 20 and/or the computing environment 12 as discussed in connection with FIG. 2. In step 502, the system determines that there are more users than appropriate for the application. In one embodiment, the process of FIG. 4A is used to generate a separate model for each user in the field of view. The system may compare the number of models that were generated with the number of users that are allowed.

In step 504, each model is analyzed to determine a level of intent for that model. In one embodiment step 504 includes performing steps 308, 310, 312, 318 and 320 to determine values for parameters for each model, scores for the parameters, and levels of intent for each user. The levels of intent may be an aggregated level of intent that is based on parameter values from different time periods. Note that step 504 does not necessarily include determining whether the level of intent of a given model indicates an intent to engage with the system, although it could. Thus, steps 314 and 322 do not necessarily need to be performed.

In step 506, models with the highest level of intent to engage the system are selected. Therefore, users corresponding to the selected models are allowed to engage the system. For example, actions of two selected users are allowed to control a game being run by the system. However, actions of other users that are detected by the system may be ignored.

If steps 314 and/or 322 were performed during step 504 to determine whether users have a sufficiently high level of intent to engage the system, step 506 might determine that there are fewer qualified users than allowed for the present application. If so, the system might only allow those with a sufficiently high intent level to engage the system. However, the system might also modify the threshold needed to determine whether a user's actions imply sufficient intent in order to allow more users to engage the system.

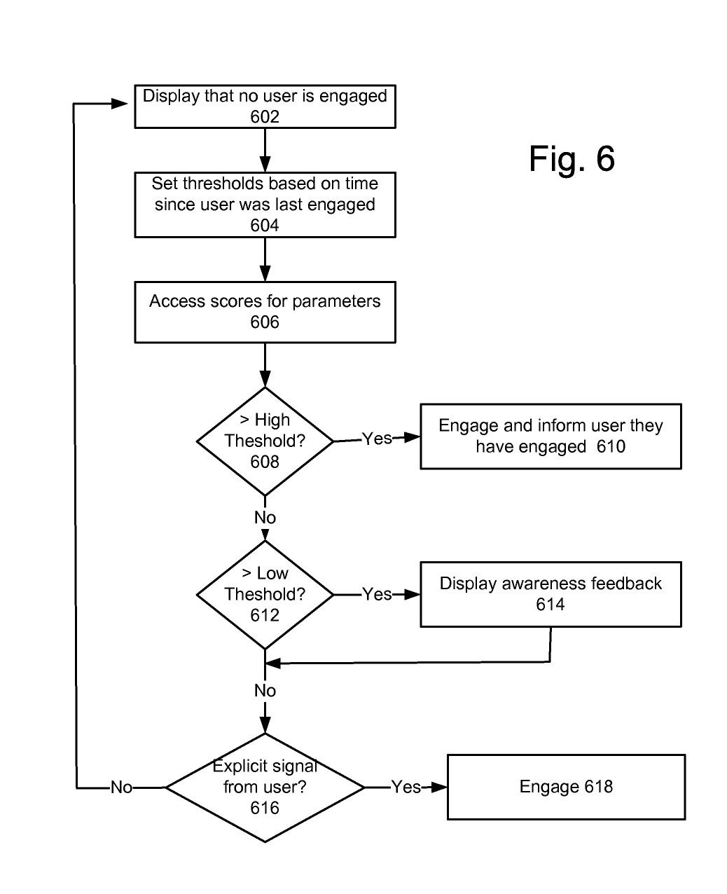

In some embodiments, the system employs both a high threshold and a low threshold. FIG. 6 is a flowchart of one embodiment of a process that uses a high and a low threshold when determining whether a user intends to engage with the system. The process is one embodiment of either step 312 or 320 of FIG. 3. In step 602, the system presents a signal that indicates that presently no user is engaged with the system. This could be a visual signal; however auditory signals are not precluded.

In step 604, thresholds for determining intent are set based on the length of time since a user last engaged the system. This allows a user that has recently engaged the system to re-engage more quickly. Moreover, it may help to prevent false positives. In one embodiment, there are two thresholds. A high threshold may be used to determine whether the user intends to engage the system. A lower threshold may be used to determine that the user might wish to engage the system, but has not yet demonstrated sufficient actions (posture, location, etc.) from which to infer intent. In the latter case, the system may present a signal to the user that the system is aware of the user, but that the user has not yet engaged the system.

In step 606, scores for the parameters are accessed. These scores may be the scores from the present time period or the modified scores from previous time periods. Thus, the scores may be those that were generated in step 310 or 318 of FIG. 3.

In step 608, the system determines whether the scores cross the high threshold. For example, the system could add the scores from the present time period to determine whether they are greater than the high threshold. As another example, the system could add the scores from the present time period and the modified scores from the previous time periods to determine whether they are greater than the high threshold. As still another example, a weighted average of scores from different time periods be computed. However, other techniques could be used.

Note that in some cases, the user actions for the present time interval may be insufficient to cross the high threshold. However, when the modified scores from the previous time periods are aggregated, then the threshold might be crossed. Therefore, the user might engage the system more quickly if their actions strongly infer intent. Stated another way, the user might engage the system more slowly if their actions weakly infer intent.

If the high threshold is crossed (as determined by step 608), then the system may enter a mode in which selected user actions (e.g., hand gestures) are interpreted as input (step 610). The system may also present feedback to the user that they have successfully engaged the system. Any type of feedback may be used, including but not limited to, visual and auditory.

If the high threshold is not crossed, then the process continues on to determine whether the low threshold is crossed (step 612). For example, the system could add the scores from the present time period to determine whether they are greater than the low threshold. As another example, the system could add the scores from the present time period and the modified scores from the previous time periods to determine whether they are greater than the low threshold. However, other techniques could be used.

If the low threshold is crossed, then the system may present feedback to the user that indicates that the system is aware of the user, but that the user has not yet engaged the system (step 614). Any type of feedback may be used, including but not limited to, visual and auditory. By presenting such feedback the user may be encouraged to take further steps to attempt to engage the system, or might try to avoid engaging the system.

Whether or not the low threshold is crossed, the process continues on to determine whether there is an explicit signal from the user to engage the system in step 616. For example, there might be an explicit signal that the system recognizes. Such a signal could be a visual or audio signal, for example.

In some embodiments, certain user actions that occur after the low threshold is crossed are interpreted differently than if neither the high or low threshold is crossed. For example, a brief hand motion from the user at this time might indicate that the user wants to engage the system. However, such a hand motion might have been ignored if neither the high or low threshold was crossed. As another example, the user might make a signal that indicates that the user does not wish to engage the system at this time.

If the user makes an explicit request to engage the system (as determined by step 616), then the system engages the user in step 618. Thus, selected user actions detected by the motion capture system are now interpreted as input to the system. Note that test for the explicit signal from the user is shown in a particular location in the process as a matter of convenience of explanation. The user could make such a request at any time.

As mentioned, there are many different parameters that may be considered when determining the level of intent to engage the system. In some embodiments, the system first determines a value for each of these parameters. For example, the system might determine angle of hip rotation. Then, the system determines a score for the value, wherein a higher score may indicate a higher level of intent. In some embodiments, the score could indicate a degree of intent to engage or a degree of intent to disengage. As one example, positive scores may be used for intent to engage and negative scores may be used for intent to disengage; however, another scoring system could be used. Next, the system determines an overall level of intent for the scores. As mentioned, these may be scores for the present time, and/or modified scores from previous time periods. The following are example parameters that may be used. This list is for purposes of illustration and should not be interpreted as limiting to these parameters.

Movement of the user's whole body, or any body part, may be considered as a parameter. Note that for some systems (e.g., hand-based gesture system) users intending to interact may be likely to remain in a relatively consistent position and body posture over short periods of time. Values for the movement parameter might include a vector based on position, direction, and velocity. In some embodiments, a higher score is given for less movement. For example, a user that is standing still might have a higher intent to engage the system.

The score for the body motion parameter might be based on comparing the vector with a physical interaction zone (PHIZ). In one embodiment, the system defines a physical interaction zone (PHIZ) within the depth camera's field of view. The PHIZ may have any shape. For example, the PHIZ may have boundaries that are intended to capture a typical user's hand gestures. As an example, the PHIZ could be defined as a region having upper, lower, left and right boundaries. The score may depend on whether the user's hands are entering or leaving the PHIZ, as one example.

Rotation of the user's upper body may be considered as a parameter. For example, facing towards the system may imply intent to engage. This might be based on angle of rotation of hips, shoulders, or another body part. The direction of a person's gaze may also be considered. In some embodiments, there is a range of angles that are considered to strongly imply intent to engage. However, once the user is within that range of angles, strong intent to engage may still be implied even if the user goes slightly outside those angles. Therefore, the scores that are assigned for a particular value (for example, hip or shoulder angle) can be adjusted in real time based on previous user actions.

Head orientation and/or gaze detection may be parameters. Note that these parameters might not be based on skeletal data. In one embodiment, the direction of the user's gaze is determined using feature recognition software. As one example, the system might be equipped with facial recognition software. However, it is not required to determine who the actual user is. Rather, it is sufficient to be able to determine the direction of the gaze. Therefore, the feature recognition software need not have the ability to recognize the specific user.

The location of the one or both user's hands may be considered as a parameter. For example, determinations can be made when a user's hands enter or leave the PHIZ. Moreover, the direction in which the user's hands last entered or left the PHIZ may be tracked. In one embodiment, the direction in which each hand last entered/exited the PHIZ is tracked as a parameter. For example, dropping a hand out of the bottom edge of the PHIZ may be a stronger negative signal of intent than moving out of the left or right edges during a large gesture.

Hand posture may be a parameter. Hand posture may include, but is not limited to, direction palm of hand is facing, direction fingers are pointing, and orientation of each finger (e.g., closed, open). Note that hand posture might be determined based on skeletal data if that data is sufficiently detailed. For example, if the skeletal data included data regarding the thumb and fingers, then this may be the case. However, it is not required to have detailed skeletal data to determine hand posture. In one embodiment, feature recognition software is used to determine hand posture.

The dominant plane of hand movement within a short period of time relative to expected gestures may be used as a parameter. For example, a system that allows hand gestures may expect (though not require) the hand gestures to appear in a certain X/Y plane. The degree to which the user's hand motion matches the expected X/Y plane may positively correlate with intent to engage the system.

The period of inactivity for an engaged user may be a parameter. For example, lack of motion in the user's hands may diminish intent to engage the system.

Measured progress towards an explicit engagement gesture may be a parameter. For example, a user waving or making a speech/audio cue may speed up engagement. An example of this is presented in step 616 of FIG. 6.

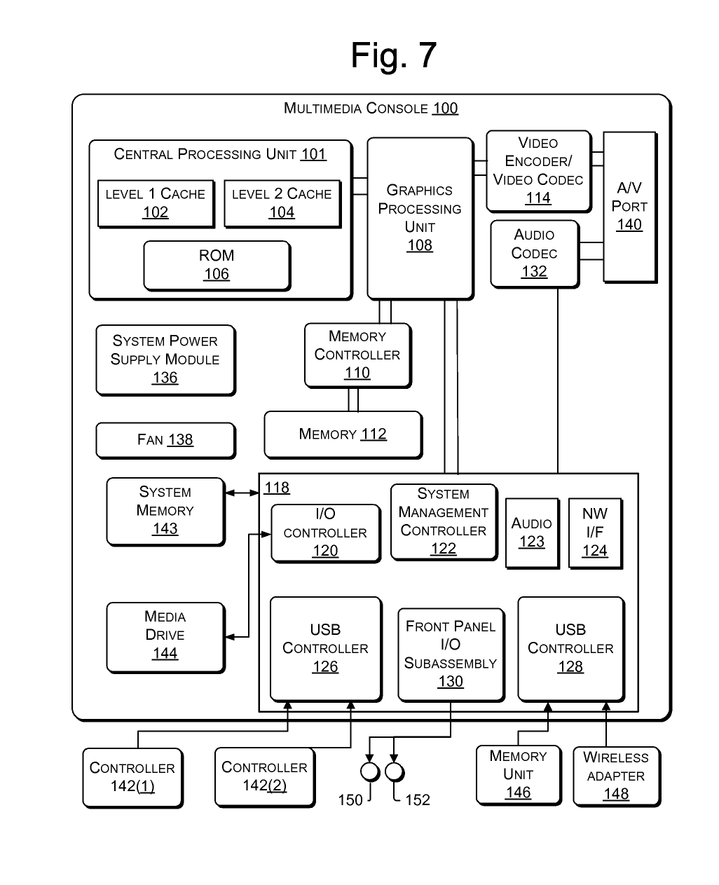

Various embodiments described herein may be performed, at least in part, within a computing environment. FIG. 7 depicts an example block diagram of a computing environment that may be used in the motion capture system of FIG. 1a, FIG. 1b, and FIG. 2. The computing environment may also be used when performed at least some steps of the processes described in FIGS. 3, 4a, 5 and 6. The computing environment can be used to determine a user's level of intent to engage a motion capture system. Once the user is engaged, the computing environment can also interpret one or more gestures or other movements and, in response, update a visual space on a display. The computing environment such as the computing environment 12 described above with respect to FIGS. 1a, 1b and 2 may include a multimedia console 100, such as a gaming console. The multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered on.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection.

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered on, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered on, a specified amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications may be scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The console 100 may receive additional inputs from the depth camera system 20 of FIG. 2, including the cameras 26 and 28.

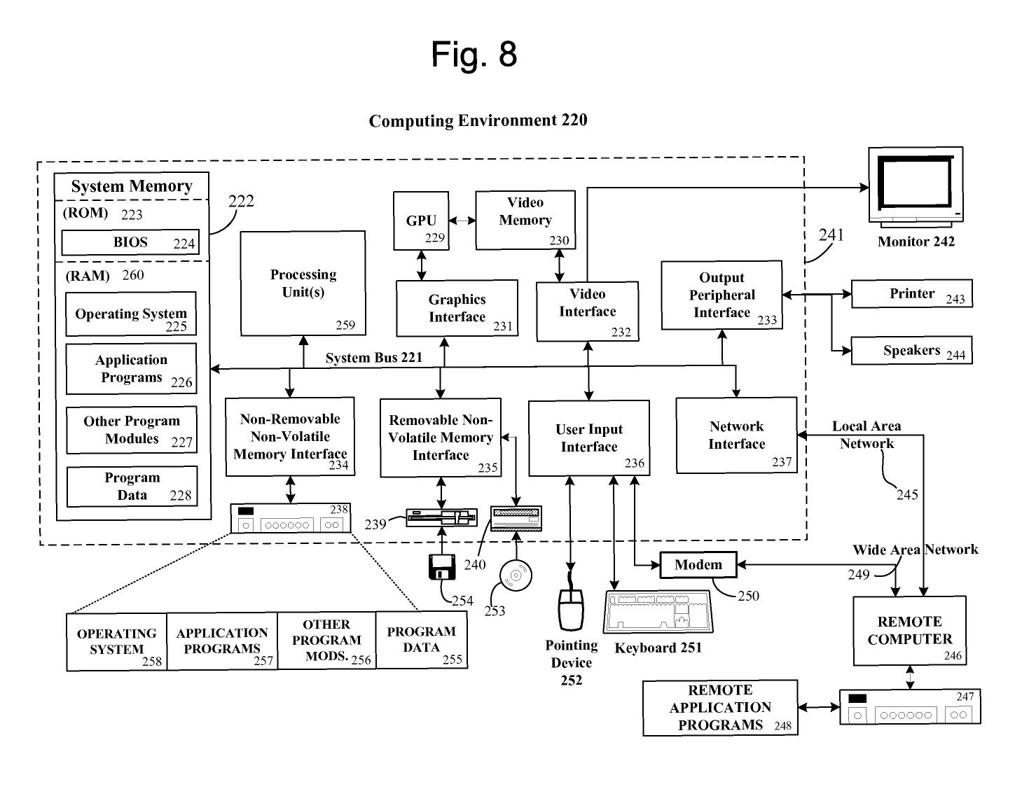

FIG. 8 depicts another example block diagram of a computing environment that may be used in the motion capture system of FIG. 1a, FIG. 1b, and FIG. 2. The computing environment may also be used when performed at least some steps of the processes described in FIGS. 3, 4a, 5 and 6. The computing environment can be used to determine a user's level of intent to engage a motion capture system. Once the user is engaged, the computing environment can be used to interpret one or more gestures or other movements and, in response, update a visual space on a display. The computing environment 220 comprises a computer 241, which typically includes a variety of tangible computer readable storage media. This can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 8 depicts operating system 225, application programs 226, other program modules 227, and program data 228.

The computer 241 may also include other removable/non-removable, volatile/nonvolatile computer storage media, e.g., a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile tangible computer readable storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and depicted in FIG. 8, provide storage of computer readable instructions, data structures, program modules and other data for the computer 241. For example, hard disk drive 238 is depicted as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to depict that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The depth camera system 20 of FIG. 2, including cameras 26 and 28, may define additional input devices for the console 100. A monitor 242 or other type of display is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been depicted in FIG. 4. The logical connections include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 8 depicts remote application programs 248 as residing on memory device 247. It will be appreciated that the network connections shown are exemplary and other means of establishing a communications link between the computers may be used.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A machine-implemented method comprising:
collecting data that describes a person's body within a field of view of a motion capture system, the data is collected over time;
generating a model for the person's body for each of a plurality of time periods based on the data;
generating a value for each of a plurality of parameters for each of the models, the value of each of the parameters defines an aspect of the person's body that pertains to a level of intent to engage the system;
aggregating a level of intent to engage the system based on the parameter values for each of the models;
interpreting selected user actions captured by the motion capture system as input to the system if the aggregated level of intent exceeds a threshold; and
interpreting the selected user actions captured by the motion capture system as noise if the aggregated level of intent does not exceed the threshold.

2. The machine-implemented method of claim 1, further comprising:
determining whether the values for the parameters strongly or weakly indicate that the person intends to engage the system; and
providing feedback to the person that indicates that the system is aware of the presence of the person, but interpreting the selected user actions captured by the motion capture system as noise, if the values for the parameters weakly indicate the person intends to engage the system;
the interpreting selected user actions captured by the motion capture system as input to the system includes determining that the values for the parameters strongly indicate intent to engage the system.

3. The machine-implemented method of claim 1, wherein generating a value for each of a plurality of parameters includes inferring a level of intent to engage the system for each individual one of the parameters.

4. The machine-implemented method of claim 1, wherein the aggregating a level of intent to engage the system is further based on time passed since the person was last engaged with the system.

5. The machine-implemented method of claim 1, further comprising:
modifying a weight given to each of the parameters for previous time periods.

6. The machine-implemented method of claim 5, wherein the modifying a weight given to each of the parameters for previous time periods includes providing progressively less weight to parameters from older time periods.

7. The machine-implemented method of claim 1, wherein the data that describes the person's body includes skeletal data.

8. The machine-implemented method of claim 1, wherein the selected user actions include hand gestures.

9. A motion capture system, comprising:
an image camera component having a field of view;
a display; and
logic in communication with the image camera component and the display, the logic is operable to:
collect data that describes a person's body within the field of view of an image camera component, the data is collected over time;
generate a model for the person's body for each of a plurality of time periods based on the data;
generate a value for each of a plurality of parameters for each of the models, each of the parameters defines an aspect of the person's body that pertains to a level of intent to engage the motion capture system;
aggregate a level of intent to engage the system based on the values for the parameter for each of the models;
determine whether the aggregated level of intent strongly indicates intent to engage the motion capture system;
interpret selected user actions captured by the depth camera as input to the motion capture system if the aggregated level of intent strongly indicates intent to engage the motion capture system;
determine whether the aggregated level of intent weakly indicates intent to engage the motion capture system; and
provide feedback that indicates that the motion capture system is aware of the presence of the person, but not allowing the person to engage the motion capture system, if the aggregated level of intent weakly indicates intent to engage the motion capture system; and
interpret the selected user actions as noise if the aggregated level of intent neither strongly nor weakly indicates intent to engage the motion capture system.

10. The motion capture system of claim 9, wherein the logic is further operable to:
generate a separate model for each person's body within the field of view of the image camera component, the separate models are based on data collected within the field of view;
determine that there are more people in the field of view than are allowed to interact with the system at the present time, the system allows a certain number of people to interact at the present time; and
analyze each model to select the certain number of people with the highest level of intent to interact with the system.

11. The motion capture system of claim 10, wherein the data includes skeletal data for each person's body with the field of view, wherein the logic is further operable to:
generate a set of parameters for the skeletal data for each person in the field of view, a set of parameters are generated for each of the time periods; and
determine an aggregated level of intent for each person based on the sets of parameters for each of the time periods.

12. The machine-implemented method of claim 9, wherein the logic is further operable to determine whether the level of intent strongly indicates intent to engage the system based on time passed since the person was last engaged with the system.

13. The motion capture system of claim 9, wherein the logic is further operable to:
determine a score based on the value for each parameter for each time period, each score represents a level of intent that is inferred for the associated value of the parameter.

14. The motion capture system of claim 13, wherein the logic is further operable to: modify the scores associated with the parameters for previous time periods in order to alter the weight given to the parameters from previous time periods.

15. The motion capture system of claim 13, wherein the logic is further operable to: devalue the scores associated with the parameters for previous time periods in order to decrease the weight given to the parameters from previous time periods.

16. A computer readable storage device having computer readable software stored thereon for programming at least one processor to perform a method in a motion capture system, the method comprising:
establishing a mode in which selected user actions are considered to be noise;
collecting data that describes a person's body within a field of view of a motion capture system, the data is collected over time;
generating a model for the person's body for each of a plurality of time periods based on the data;
generating a value for each of a plurality of parameters for each of the models, each of the parameters defines an aspect of the person's body that pertains to a level of intent to engage the system;
determining scores for each of the values, each score represents a level of intent that is inferred for the associated value of the parameter;
determining a level of intent that is inferred for the present time period based on the scores from the present time period;
interpreting the selected user actions captured by the motion capture system as input to the system if the level of intent exceeds a threshold;
modifying the scores for the parameters from previous time intervals;
determining an aggregated level of intent that is inferred based on the scores from the present time period and the modified scores from previous time intervals; and
interpreting the selected user actions captured by the motion capture system as input to the system if the aggregated level of intent exceeds a threshold.

17. The computer readable storage device of claim 16, wherein modifying the scores for the parameters from previous time intervals includes decreasing the scores based on how much time has passed since the data used to generate values for the parameters was collected.

18. The computer readable storage device of claim 16, further comprising:
determining whether the scores strongly or weakly indicate that the person intends to engage the system;
placing the system in a mode in which the person is able to engage the system by the selected actions if the scores strongly indicate the person intends to engage the system; and
providing feedback to the person that indicates that the system is aware of the presence of the person, but not allowing the person to engage the system, if the scores weakly indicate the person intends to engage the system.

19. The computer readable storage device of claim 16, wherein the data that describes the person's body includes skeletal data.

20. The computer readable storage device of claim 16, wherein the selected actions include hand gestures.
